(19) United States
(12) Patent Application Publication
(10) Pub. No.: US 2020/0096418 A1
(43) Pub. Date: Mar. 26, 2020

(54) METHOD AND DEVICE FOR ESTIMATING THE STATE OF WEAR OF A JOURNAL BEARING

(71) Applicant: Rolls-Royce Deutschland Ltd & Co KG, Blankenfelde-Mahlow (DE)

(72) Inventors: Sebastian NOWOISKY, Michendorf (DE); Noushin MOKHTARI MOLK ABADI, Berlin (DE); Mateusz GRZESZKOWSKI, Berlin (DE)

(21) Appl. No.: 16/553,978

(22) Filed: Aug. 28, 2019

(30) Foreign Application Priority Data
Sep. 25, 2018 (DE) 10 2018 123 571.2

(51) Int. Cl. G01M 13/045; F16C 17/24; F16C 33/12; G01L 1/25; G01L 1/10

(52) U.S. Cl. CPC G01M 13/045; F16C 17/246; G01L 1/106; G01L 1/255; F16C 33/125

(57) ABSTRACT

A method for estimating the state of wear of a plain bearing comprises: establishing a time profile of at least one friction event from a structure borne noise signal by a mathematical friction event model, determination of a measure, which characterizes at least one friction event based on a time duration of the at least one friction event, the amplitude of the at least one friction event and/or an integral measure over the at least one friction event, combination of the measure, accumulated over time, with an angle indication for the at least one friction event at the circumference of the plain bearing in order to determine a spatially resolved wear model of the plain bearing, wherein the spatially resolved wear model is obtained by an estimating filter, and outputting a signal in accordance with the wear model to characterize the state of wear.

### REFERENCE TO THE RELATED PATENT APPLICATION

This patent application claims the priority of the German patent application no. 10 2018 123 571.2 filed on Sep. 25, 2019, the entirety of which has been incorporated herein by reference.

### BACKGROUND

The proposed solution relates to a method for estimating the state of wear of a plain bearing and to a device for estimating the state of wear of a plain bearing.

Plain bearings are a versatile machine element in which the relative motion between a shaft and the bearing shell of the plain bearing or an intermediate medium is a sliding motion.

One area of application for plain bearings is, for example, the mounting of planet gears in planetary gearboxes that are used or intended for use in turbofan aircraft engines.

The demands on new engines in respect of fuel consumption, CO₂ emissions and noise emissions are continuously increasing, and therefore engine components must be constantly improved. In future turbofan engines, the intention is to achieve this by decoupling the compressor and the turbine from the fan through the use of a high-performance planetary gearbox. This will enable these components to be operated at their respective optimum operating points. The lower fan speed that is possible as a result enables the fan diameter to be increased, leading to a higher bypass mass flow without simultaneously generating supersonic noise at the fan tips.

In high-performance gearboxes, use is made of planetary transmissions, the components of which, e.g. gears, shafts and bearings, represent potential wearing parts. Failure of these components can have grave consequences for the overall aircraft engine. In this context, friction events (solid body friction events, mixed friction events) play a major role in plain bearings since they indicate that the lubricant has been lost from the desired viscous friction zone.

### SUMMARY

For this reason, there is a need for methods and devices to make the operation of plain bearings safe. This also includes, in particular, estimating the degree of wear of the plain bearing since said bearing is not open to direct observation during operation.

This aspect is addressed by a method having the features described here.

A method for estimating the state of wear of a plain bearing is employed, wherein at least one time-dependent structure borne noise signal is recorded by at least one structure borne noise sensor, in particular precisely one structure borne noise sensor.

First of all, the time profile of at least one friction event in the plain bearing is established from the structure borne noise signal by means of a mathematical friction event model (e.g. using an envelope curve model).

This is followed by determination of a measure which characterizes at least one friction event based on the time duration of the at least one friction event, the amplitude of the at least one friction event and/or an integral measure over the at least one friction event.

Combination of the measure, accumulated over time, with an angle indication ϕ(t) for the at least one friction event at the circumference of the plain bearing is then performed to obtain a spatially resolved wear model of the plain bearing. This model includes indication of the location of the friction events (e.g. as an indicator of a location of damage) and the intensity (e.g. as an indicator of the extent of the damage). The intensity can be obtained from the amplitude, for example.

Finally, a signal is output in accordance with the wear model to characterize the state of wear. This can take the form of a warning of the need for maintenance to be performed, for example. It is thereby possible, using a 3-D resolution that can be obtained for the degree of wear, to make a judgment on the remaining service life. This can be accomplished with the aid of statistical methods (e.g. a Kalman filter), for example. At the end of the service life (or even somewhat earlier), a message can be issued to the effect that the plain bearing will soon no longer be functional (e.g. by means of a warning lamp). In addition, however, the remaining residual service life under the currently prevailing operating conditions can also be monitored during operation, making it possible for the personnel themselves to decide the time to intervene.

Friction events, e.g. mixed friction events or solid body friction events, are a fundamental part of an operating history of a plain bearing. If these friction events occur more frequently or to an increasing extent, this indicates that the plain bearing may be damaged or is on the way to being damaged. Beyond a certain point, there is the risk of seizure. By means of the estimation, proposed here, of the state of wear, which is spatially resolved over the circumference of the plain bearing, information on the state of the bearing is obtained during the operation of the plain bearing without removing and inspecting the plain bearing.

The spatially resolved wear model is obtained by means of an estimating filter, in particular a Kalman filter, an extended Kalman filter and/or a regression.

In addition, it is possible in one embodiment for the number of friction events to be counted and used to generate a signal for service life estimation. Here, the absolute frequency of the friction events or an increase over time can be a measure of the wear.

In this context, the friction events can comprise mixed friction and/or solid body friction events.

Furthermore, a correlation of the frequencies of the friction events and/or between the feature determined (from the structure borne noise) and the degree of wear can be carried out.

If current operating data, in particular the operating duration, a temperature, in particular an oil temperature, load data, acoustic data in frequency ranges outside the friction events and/or a measured rotational speed are included in the service life estimation, the service life estimation can be displayed as a continuously updated value. The estimation itself can also be improved by taking into account the operating data. If, for example, operating data of structurally identical and/or structurally similar plain bearings are included in the service life estimation, it is also possible to incorporate historical findings into the service life estimation. It is also possible to include a priori information in the service life estimation.

In another embodiment, at least one mixed friction event is ascertained on the plain bearing with a shaft mounted therein, in particular rotating therein. The at least one mixed friction event can be ascertained while the plain bearing is rotating and the shaft is at rest or while the shaft is rotating and the plain bearing is at rest.

During this process, at least one time-dependent structure borne noise signal of the at least one structure borne noise sensor, in particular precisely one structure borne noise sensor, is recorded. The method can also equally be carried out with just one structure borne noise sensor, thus allowing a particularly economical sensor system.

First of all, the time-dependent structure borne noise signal is filtered in order, in particular, to suppress other mechanical vibration. In the case of mixed friction events, the structure borne noise signal has an amplitude modulation.

The calculation of an envelope curve for the filtered structure borne noise signal is then performed, wherein, in the case of mixed friction events, the envelope curves envelop the amplitude-modulated signal.

The envelope curve generally still has sharp contours, e.g. spikes, making it difficult to determine the maxima in the envelope curve, which indicate the mixed friction events. The envelope curve is therefore subjected to smoothing.

The data of the smoothed envelope curve are combined with the rotation angle signal, which is dependent on the rotation of the shaft in the plain bearing. The combination is also referred to as fusing the data.

This makes it possible to identify the periodicity of the maxima. The maxima that indicate the mixed friction events occur in similar form in each revolution of the shaft.

The local maxima are then calculated from the combined data from the preceding step to determine an angle indication for the mixed friction events at the circumference of the plain bearing. In the case where there is only one mixed friction event, only one maximum is determined.

It is thereby possible to associate mixed friction events spatially to certain points in the plain bearing in a simple and robust manner. This can for example supplement time-based maintenance with state-based maintenance to enable increased safety to be offered for people, machines and the environment, and to enable the machine service life to be extended and to allow maintenance work to be planned more effectively.

In one embodiment, the rotation angle signal is determined and/or generated by pattern recognition or by means of a reference pulse by an incremental encoder, in particular a magnetic reference pulse.

The rotation angle signal can be generated in various ways. In one variant embodiment, the rotation angle signal is generated exclusively by the movement of the shaft and/or of the plain bearing, in particular by at least one magnetic element of the shaft and/or in the plain bearing and a correspondingly associated magnetic sensor (e.g. a coil). This is passive generation of the rotation angle signal exclusively by the relative motion of the shaft and the plain bearing.

In addition or as an alternative, the rotation angle signal can be generated actively by means of at least one pulse, in particular a zero pulse or a multiplicity of pulses of the incremental encoder. In principle, one pulse, e.g. the zero pulse, is sufficient. If a plurality of pulses is used, accuracy can be increased.

In one embodiment, the filtering of the structure borne noise signal can be performed by means of a high pass filter, in particular with a cutoff frequency between 50 and 300 kHz, in particular between 80 and 150 kHz. The frequencies of mixed friction events differ from other mechanical vibration in a plain bearing, and therefore the mixed friction events can be filtered out of the overall vibration spectrum in an effective manner.

Furthermore, the calculation of the envelope curve can be performed by means of a Hilbert transformation or by averaging over a predetermined quantity of filtered structure borne noise data points.

In one embodiment, the envelope curve can be smoothed by means of a smoothing filter, in particular a Savitzky-Golay filter.

In one embodiment, a computer acquires and stores the time-dependent data on the angle indication, the angular location, the intensity and/or the duration of the at least one mixed friction event at the circumference of the plain bearing and, if a predetermined condition occurs, outputs a signal, in particular a warning signal or a repair signal. The computer can detect, for example, if a certain number of mixed friction events per revolution and/or a certain spatial concentration of mixed friction events has occurred. Depending on the system under consideration into which the plain bearing is integrated, it is possible to formulate conditions which may be considered as acceptable or, indeed, no longer acceptable. In the latter case, it is then possible, for example, for a signal to be output that indicates possible failure of the plain bearing.

In one embodiment of the method, the plain bearing is arranged in a planetary gearbox, in particular in a planetary gearbox in a vehicle, a wind turbine or an aircraft engine. Generally speaking, planetary gearboxes must operate without maintenance for prolonged periods, and therefore monitoring, especially for possible prediction of damage, is worthwhile.

It is also possible to filter out motion data and/or structure borne noise events of the planetary gearbox, in particular the motion data and/or structure borne noise events of the movements of the sun gear, planet carrier and/or planet gears. The frequency ranges of these events are often below the frequency range in which mixed friction events occur.

The object is also achieved by a device for estimating the state of wear of the plain bearing having the features described here.

Here, at least one time-dependent structure borne noise signal can be recorded by at least one structure borne noise sensor, in particular precisely one structure borne noise sensor of the plain bearing.

A first computation means is used to establish the time profile of at least one friction event from the structure borne noise signal by means of a mathematical friction event model.

A second computation means determines a measure which characterizes the at least one friction event based on the time duration of the at least one friction event, the amplitude of the at least one friction event and/or an integral measure over the at least one friction event.

A third computation means is then used to combine the measure, accumulated over time, with an angle indication for the at least one friction event at the circumference of the plain bearing. By means of this combination, it is possible to determine a spatially resolved wear model of the plain bearing, wherein a signaling means for outputting a signal in accordance with the model is used to characterize the state of wear.

By means of such a device, which can be in the form of a micro processor for example, efficient monitoring of a plain bearing for mixed friction events is possible.

In one embodiment, it is possible in this context for the at least one structure borne noise sensor to be arranged on the end of a holder of the plain bearing.

In one possible design of the at least one structure borne noise sensor, a piezoelectric element is used to record the structure borne noise.

For efficient detection of structure borne noise in the case of mixed friction events, the at least one structure borne noise sensor can be arranged in the immediate vicinity of the circumference of the plain bearing, in particular in the immediate vicinity of the introduction of a force.

### BRIEF DESCRIPTION OF THE DRAWINGS

The proposed solution will be discussed in connection with the exemplary embodiments illustrated in the figures.

FIG. 1 shows a schematic structure borne noise signal in the case of mixed friction between a shaft and a plain bearing with an amplitude modulation.

FIG. 2 shows a schematic illustration of an embodiment for wear estimation on a plain bearing with determination of the angular resolution of the structure borne noise signal.

FIG. 2A shows a schematic illustration of a time-dependent structure borne noise signal with mixed friction events.

FIG. 3 shows another embodiment for wear estimation on a plain bearing.

FIG. 4A shows a front view of one embodiment of a plain bearing device.

FIG. 4B shows a perspective illustration of the plain bearing device shown in FIG. 4A.

FIG. 4C shows another perspective illustration of the plain bearing device shown in FIG. 4B.

FIG. 5 shows a schematic illustration of a test setup for monitoring the plain bearing.

FIG. 6 shows a structure borne noise signal and a Z signal of an incremental encoder for a plain bearing assembly with a rotational speed of 340 rpm in the case of viscous friction.

FIG. 7 shows a structure borne noise signal measured over two revolutions of a shaft in a plain bearing with four mixed friction events (rubbing contacts) per revolution.

FIG. 8 shows the structure borne noise signal shown in FIG. 7 for one revolution indicating the angle of the mixed friction events (rubbing contacts).

FIG. 9 shows an illustration of the energy of the envelope of the structure borne noise signal and of the Z signal without smoothing.

FIG. 10 shows an illustration of the energy of the envelope of the structure borne noise signal and of the Z signal with smoothing.

FIG. 11 shows an embodiment of the monitoring of a plain bearing for mixed friction events in a planetary gearbox.

FIG. 12 shows another embodiment of the monitoring of a plain bearing for mixed friction events in a planetary gearbox.

### DETAILED DESCRIPTION

The monitoring of hydrodynamic plain bearings for mixed friction events is described below with reference to a number of illustrative embodiments.

Theoretically, a hydrodynamic plain bearing 1 has an infinite service life as long as the shaft 6 and the lining of the plain bearing 1 are separated from one another by a loadbearing lubricating film. As soon as these two components come into contact, there is mechanical friction (mixed friction, solid body friction), which ultimately leads to damage. As a result, the plain bearing 1 can lose its ability to function since it is no longer possible for a loadbearing lubricating film to form in the presence of increased abrasion or damage.

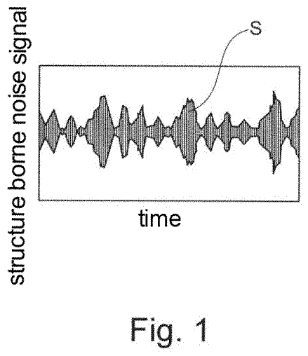

Embodiments relating to the estimation of the state of wear are described below, proceeding in one step on the basis that the time profile of a friction event a, b, c, d is determined from a structure borne noise signal S by means of a mathematical friction event model R. First of all, therefore FIGS. 1 to 9 illustrate how the friction events a, b, c, d, in particular the mixed friction events, are ascertained from detected structure borne noise.

One known method for monitoring hydrodynamic plain bearings 1 uses shaft orbit plots (see J. Deckers, “Entwicklung einer Low-Cost Körperschallsensorik zur Überwachung des Verschleiβverhaltens von wälz-oder gleitgelagerten Kreiselpumpen kleiner Leistung”, [Development of a Low-Cost Structure Borne Noise Sensor System for Monitoring the Wear Behavior of Low-Power Centrifugal Pumps with Rolling or Plain Bearings] Dissertation, Gerhard Mercator-Universitat Duisburg, Duisburg, 2001).

Here, the shaft orbit within the plain bearing is detected by two position sensors mounted orthogonally on the plain bearing 1. The two phase-shifted position signals detected in this case are represented in polar coordinate form in “orbit plots”. These plots represent the rotation angle-dependent movement of the supported shaft 6 transversely to the axial shaft axis.

To detect the phase position, a “key phasor” (reference transducer) is used.

If the shaft 6 then leaves the permitted orbit, a rubbing contact (i.e. a mixed friction event) between the shaft 6 and the lining of the plain bearing 1 has taken place. This can be identified in the shaft orbit plot.

By means of this method, it is not only possible to identify a rubbing contact process but also to ascertain the intensity and position of the contact in the circumferential direction of the plain bearing lining. Mixed friction events a, b, c, d are discussed below but the technical teaching is not restricted to this type of friction analysis.

The mutual contact between roughness peaks on the two sliding partners in a mixed friction event (rubbing contact process) causes structure borne noise with a frequency of up to 2 MHz in the plain bearing 1.

As compared with other diagnostic methods, the use of structure borne noise analysis offers advantages in respect of early detection of bearing damage to the plain bearing 1 (see M. Fritz, A. Burger and A. Albers, “Schadensfrüherkennung an geschmierten Gleitkontakten mittels Schallemissionsanalyse,” [Early Detection of Damage to Lubricated Sliding Contacts by Means of Noise Emission Analysis], Institut für Maschinenkonstruktionslehre and Kraftfahrzeugbau, Bericht, Universität Karlsruhe, 2001; P. Raharjo, “An Investigation of Surface Vibration, Airborne Sound and Acoustic Emission Characteristics of a Journal Bearing for Early Fault Detection and Diagnosis,” Dissertation, University of Huddersfield, May 2013)

By means of suitable signal processing and feature extraction algorithms, it is possible to distinguish viscous friction, which does not affect the service life, from mixed and solid body friction, which reduce the service life. However, the algorithms used for diagnosis by means of structure borne noise assess the state of friction only globally, not locally, over the circumference of the plain bearing 1, i.e. there is no angular resolution in the identification of the mixed friction events a, b, c, d.

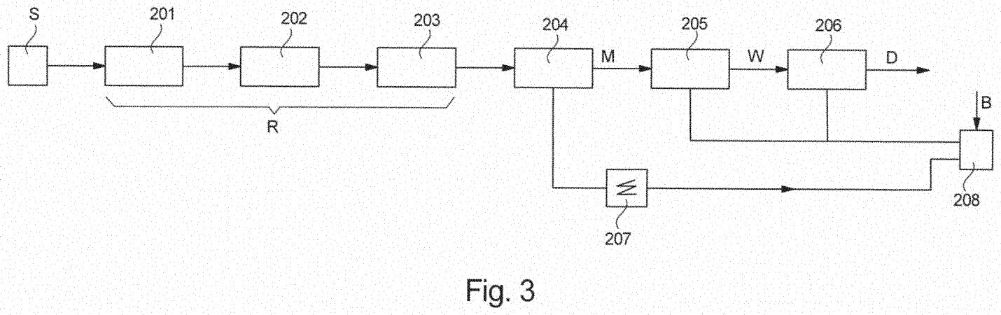

But a knowledge of local mixed friction processes a, b, c, d is essential for characterization of the state of wear of plain bearings 1. Repeated friction at the position α=20° for example (plotted in FIG. 3A for example) reduces the service life of the plain bearing 1 more than the same number of friction processes distributed over the circumference.

One phenomenon which occurs with the superposition of a high-frequency carrier signal and a low-frequency useful signal is amplitude modulation.

In the case of local contact between the shaft 6 and the lining of the plain bearing 1, there is likewise amplitude modulation of the structure borne noise signal (see M. Leahy, D. Mba, P. Cooper, A. Montgomery and D. Owen, “Experimental investigation into the capabilities of acoustic emission for the detection of shaft-to-seal rubbing in large power generation turbines,” Proceedings of the Institution of Mechanical Engineers, Part J: Journal of Engineering Tribology, Vol. 220, No. 7, p. 607-615, 2006; A. Albers and M. Dickerhof, “Simultaneous Monitoring of Rolling-Element and Journal Bearings Using Analysis of Structure-Born Ultrasound Acoustic Emissions,” in International Mechanical Engineering Congress & Exposition, Vancouver, British Columbia, Canada, 2010.)

The mixed friction events a, b, c, d occur in dependence on the rotational speed of the shaft 6. The mixed friction events a, b, c, d themselves each generate a structure borne noise signal, which is of significantly higher frequency than the rotation frequency of the shaft 6. Overall, a structure borne noise signal S in which a low-frequency rotation frequency and a higher-frequency structure borne noise signal are superposed is recorded.

The diagrammatic signal profile of the structure borne noise signal S can be seen in FIG. 1. The modulations which occur differ in amplitude and duration.

In the case of viscous friction, with which no rubbing contact processes occur between the shaft 6 and the lining of the plain bearing 1, no amplitude modulations occur.

As mentioned above, the exact circumferential position (i.e. the angle α) at which mixed friction events a, b, c, d occur represents important information, including for service life prediction. Thus, the accumulation of mixed friction events a, b, c, d at one circumferential position can be interpreted as a measure of the wear of the plain bearing lining. Service life prediction can also be improved. It is also possible, for example, to form the integral over one revolution in each case and this takes account of the intensity and duration of the friction event at the same time.

The intention is, with appropriate monitoring, to keep both the complexity of the measurement chain and the costs for the production of a product (in this case the diagnostic or prediction system) as low as possible. Reducing sensor numbers, ideally the use of just one sensor, simplifies the measurement chain and also allows a significant cost reduction.

Embodiments which use various properties of the detected structure borne noise signal S to detect mixed friction events a, b, c, d are described below.

An envelope curve, also referred to as an envelope, envelops a family of curves (e.g. that of a structure borne noise signal S as per FIG. 1). This gives rise to a new curve, by means of which it is possible to make a judgment on local maxima and minima of the low-frequency signal modulated onto the high-frequency signal. An envelope curve can be determined by means of a Hilbert transformation, for example (see D. Guicking, Schwingungen: Theorie und Anwendung in Mechanik, Akustik, Elektrik und Optik [Vibration: Theory and Application in Mechanics, Acoustics, Electrics and Optics], Göttingen: Springer Vieweg: Springer Fachmedien Wiesbaden, 2016.).

For the application presented here, however, it is fully sufficient to know the behavior of the amplitudes for the determination of the envelope. All that is required is to ascertain where local maxima and minima occur. The envelope curve is obtained by determining the RMS (root mean square or quadratic mean) over a predetermined quantity of data points. Alternatively, it is also possible to use a Hilbert transformation. This also provides a measure of the energy of the structure borne noise signal, wherein the peak values and curve shape are taken into account in each case.

The curve formed by an envelope has bends and/or sharp angles which need to be smoothed to allow a judgment about local maxima and minima. For this purpose, it is possible, for example, to use low-order approximation polynomials to achieve the best possible smoothing. One possibility for smoothing is to use the Savitzky-Golay filter (see A. Savitzky and M. J. E. Golay, “Smoothing and Differentiation of Data by Simplified Least Squares Procedures,” Anal. Chem., July 1964).

This method smooths a signal by section-by-section fitting of a polynomial function to the signal. This fitting process employs the method of least squares between the matrix X and the vector y:

y=X b

The solution for b with the aid of the least squares is

b=(X^{T}X)⁻¹X^{T}y.

The estimated values Ŷ used for smoothing are:

Ŷ=Xb=X(X^{T}X)⁻¹X^{T}y=Hy

First of all, embodiments of the method for mixed friction localization over the circumference of the plain bearing lining by means of structure borne noise measurement are explained in more detail below.

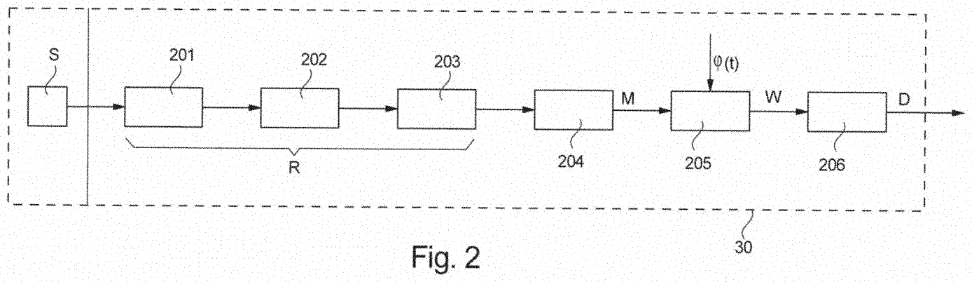

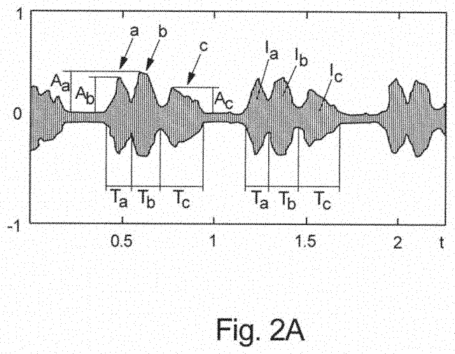

In FIG. 2, implementation steps for identifying mixed friction events a, b, c, d are described.

In a first step 201, the amplitude-modulated structure borne noise signal S is subjected to high-pass filtering in order as far as possible to attenuate disturbance signals from the surroundings and signals which have nothing to do with the mixed friction events a, b, c, d. In the present case, a cutoff frequency of 100 kHz is used. In other embodiments, it is also possible to use other cutoff frequencies. Frequencies in the range of 50 to 300 kHz are generally appropriate since the mixed friction events are very largely above these cutoff frequencies.

In the following step 202, the envelope of the structure borne noise signal S is formed, e.g. by means of Hilbert transformation. The method used here forms the average over a certain number B of signal points n, (e.g. 800) and stores this value in a vector.

As explained above, it is possible when using the RMS to determine the energy of the envelope, but this has sharp bends or spikes. To enable the local maxima and minima to be ascertained with greater numerical accuracy, a 3rd-order Savitzky-Golay filter can be used for example to smooth the structure borne noise signal S (step 203). In other embodiments, it is also possible to use other filters.

Using a first computation means, a time profile was thereby obtained by means of a mathematical friction event model R.

In step 204, a measure M, which characterizes the at least one mixed friction event a, b, c, d based on the time duration Tₐ, T_{b}, T_{c}, T_{d} of the mixed friction event a, b, c, d, the amplitude Aₐ, A_{b}, A_{c}, A_{d} of one friction event a, b, c, d and/or an integral measure over the friction event a, b, c, d is then determined, using a second computation means.

The measures are explained in greater detail in conjunction with FIG. 2A. FIG. 2A shows diagrammatically a time-dependent structure borne noise signal, by means of which three mixed friction events a, b, c are identified by means of steps 201, 202 and 203. The association with the angular regions of the circumference of the plain bearing 1 is explained below.

The three periodically occurring mixed friction events a, b, c each have different lengths Tₐ, T_{b}, T_{c}, i.e. they are a measure of the friction contact time over the circumference of the plain bearing 1. The lengths of time are thus a measure of the magnitude of the contact angle. The smaller the contact angle, the larger is the kurtosis of the signal at the same intensity. Kurtosis describes the steepness or sharpness of the signal. As the contact angle becomes larger, kurtosis decreases. Thus, kurtosis can be used as a measure M of the duration of the mixed friction events.

In addition or as an alternative, it is also possible to use the intensity of the mixed friction events a, b, c as a measure M for the mixed friction events a, b, c. The intensity can for example be determined by way of the amplitudes Aₐ, A_{b}, A_{c} (see FIG. 2A) or the RMS value. It is also possible to use an integral measure, e.g. to determine the integral over the times

Tₐ, T_{b}, T_{c}, with the result that a combined measure M is obtained which allows equally for the duration and the amplitude. It is also possible to determine the integral by means of a squared area (with or without time weighting), where the larger amplitudes (and, in the case of time weighting, events of longer duration) are given greater consideration.

In all cases, measures which, whether weighted or unweighted, characterize the duration and intensity of the mixed friction events are obtained.

The measure M, accumulated over time, is then combined in step 205 with an angular position ϕ(t) for the mixed friction events a, b, c, d at the circumference of the plain bearing in order to determine a spatially resolved wear model W of the wear model of the plain bearing 1.

The way in which the angular position ϕ(t) can be determined in one embodiment is described below.

In the illustrated embodiment, an incremental encoder is used to output pulses to the plain bearing 1. These pulses are rotation angle signals Z, which are dependent on the rotation of the shaft 6 in the plain bearing 1.

In this application, the zero pulse signal (Z signal) of the incremental encoder is used to identify the exact angular position ϕ(t) of the mixed friction events a, b, c, d. Precisely one revolution of the shaft 6 in the plain bearing 1 takes place between two square wave signals of an incremental encoder. Both signals, both the structure borne noise signal S and the Z signal Z are recoded simultaneously (step 205). For improved accuracy, it is also possible to use more than one pulse signal per revolution.

When the processed structure borne noise signal S and the Z signal Z (step 205) are superposed, it is possible to make an accurate association between the maxima—resulting from the structure borne noise of the mixed friction events—and the angular position (step 206), wherein a signal D is output in accordance with the model wear model W, and this is transmitted to an engine control system, for example.

The signals can be processed and evaluated by means of a computer 30. The signals of the structure borne noise sensor 3 can be transmitted to the computer 30 in a conventional manner, if appropriate via an amplifier. FIG. 2 illustrates that the computer performs all the steps. It is also possible for the computer 30 to operate in a decentralized manner, where individual steps of parts of the computer 30 are carried out by decentralized processors.

Here, each maximum represents a rubbing contact between the shaft and the plain bearing lining, i.e. a mixed friction event a, b, c. Given a knowledge of the signal relating to the measured angular positions, each maximum can be associated with an angle which characterizes the point of rubbing contact (i.e. the mixed friction event a, b, c) in the lining of the plain bearing 1.

FIG. 3 illustrates another embodiment, in which the method and device shown in FIG. 2 are supplemented; reference can therefore be made to the description of FIG. 2.

In step 203, the individual mixed friction events a, b, c are identified. In a counter (step 207) these are counted individually, and a sum is formed. Here, it is possible to ascertain, with the aid of features (RMS, envelope curve, kurtosis) and pattern recognition, whether there is mixed friction (or solid body friction). A distinction is not necessarily drawn between location, duration and intensity. Mixed friction events which occur are then counted up until a critical value is reached. After this, a warning signal is output.

Together with the result of step 206 and/or of signal D, the remaining service life is estimated (step 208). This process can also incorporate current operating data B.

However, it is also possible for the count E to be output and displayed separately.

If the method is used to estimate the state of wear in an engine, for example, the service life estimation could also include temperatures, such as the oil temperature in a planetary gearbox, load data, acoustic data in frequency ranges outside the friction events and/or a rotational speed, for example, as current operating data. If, for example, the engine had been operated very gently throughout, e.g. with few takeoffs and landings, a relatively long service life would be displayed. If there were a change in the operating behavior, e.g. more short distances were flown, this would be reflected by a shorter estimate for the service life.

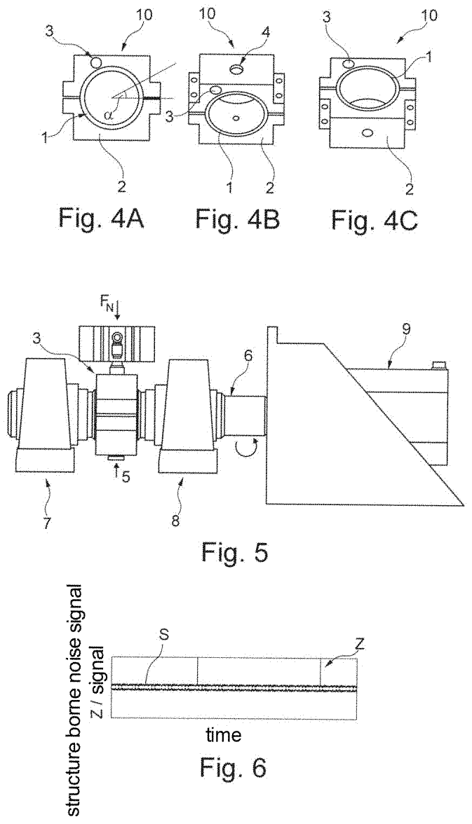

Results in which both mixed friction and—for comparison—viscous friction occurred are illustrated below. For this purpose, use was made of embodiments which are illustrated in FIGS. 4A, 4B, 4C and FIG. 5.

In FIG. 4A, a plain bearing device 10 is illustrated in a front view and, in FIGS. 4B and 4C, is in each case illustrated in a perspective view. Here, the actual plain bearing 1 (i.e. the plain bearing bush) is embedded in a holder 2, which also has the structure borne noise sensor 3. In the present case, the holder 3, the plain bearing 1 and the structure borne noise sensor 3 form a plain bearing device 10. In other embodiments, the plain bearing device 10 can also be formed from other components, in particular also from more components.

In the illustrated embodiment, just one structure borne noise sensor 3 is required and, in the illustrated embodiment, is arranged offset slightly sideways from the center, in the vicinity of the circumference of the plain bearing 1 and on the front side of the plain bearing device 10. The structure borne noise generated during the operation of the plain bearing 1 is transmitted well to the structure borne noise sensor 3 by the solid bodies. It is worthwhile here to arrange the structure borne noise sensor 3 in the vicinity of the introduction of an external force. A Physical Acoustics WD 100-900 kHz wideband sensor can be used as the structure borne noise sensor 3, for example. The structure borne noise sensor 3 can have a piezoelectric element.

In the illustrated embodiment, a force F_{N} (i.e. a bearing load) is imposed from above (see FIG. 4) on the holder 3 of the plain bearing 1, which has a supporting hole 4 for this purpose. An oil supply inlet line 5 is situated on the opposite side of the holder 3.

FIG. 5 furthermore illustrates that a shaft 6—supported in two support bearings 7, 8—is guided by the plain bearing 1. The shaft 6 is driven by an electric motor 9.

It is expected that there is no modulation in the signal obtained when the plain bearing 1 is operated with viscous friction since no rubbing contact occurs between the shaft 6 and the lining of the plain bearing 1. In the case of mixed friction events, it should be possible to detect a modulation in the signal.

Under a constant load F_{N}, a falling rotational speed ramp was run. Each rotational speed was held for three seconds. This makes it possible, at a constant load F_{N}, to move from viscous friction, which occurs at high rotational speeds, into the range of mixed friction.

The structure borne noise signal S and the Z signal Z of the incremental encoder are illustrated by way of example in FIG. 6 for a constant load F_{N} of 1500 N and a rotational speed of 340 rpm. In this range, there is viscous friction; no modulations can be detected in the signal.

The Z signal Z is the signal of the incremental encoder and is output once per revolution as a square wave signal. Precisely one revolution of the shaft 6 takes place between two square wave signals.

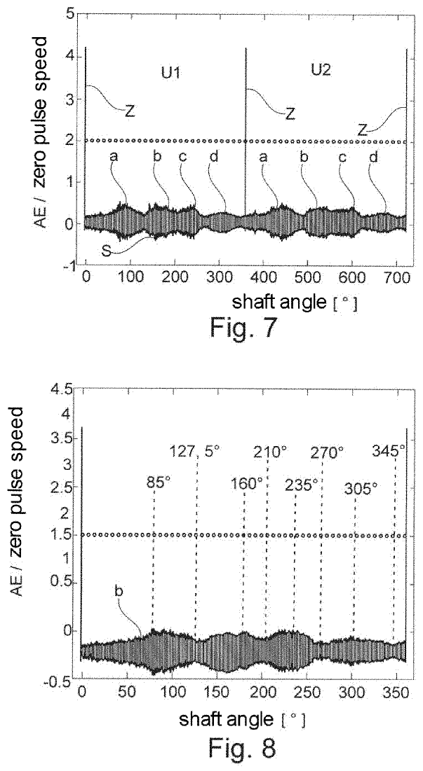

FIG. 7 shows the structure borne noise signal S and three Z signals Z, likewise for a load F_{N} of 1500 N but for a rotational speed of 80 rpm. In FIG. 7, two full revolutions U1, U2 are illustrated.

As is apparent, mixed friction events a, b, c, d take place between the shaft 6 and the lining of the plain bearing 1. The modulation in the signal can be observed in FIG. 7. Rubbing contact has occurred at each of four different points a, b, c, d within one revolution, i.e. mixed friction events a, b, c, d are present.

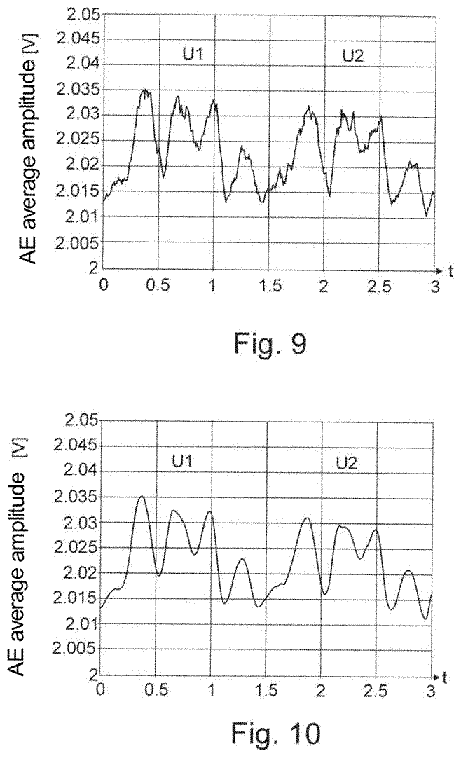

In FIG. 8, the maxima and minima in the structure borne noise signal are indicated for one revolution U1 and associated with angles on the circumference of the plain bearing 1. The determination of the maxima and minima has already been explained above and will be explained further in conjunction with FIG. 9.

This structure borne noise signal S is subsequently processed using one embodiment of the method, as illustrated, for example, in conjunction with FIG. 2 or 3. This means that the signal is filtered using a high pass filter, and the envelope is then determined by means of averaging (step 202).

The time is plotted on the x axis of FIGS. 9 and 10.

FIG. 9 illustrates the energy (i.e. as a function of RMS) of the envelope of the filtered structure borne noise signal S for two revolutions U1, U2. By the nature of the case, the Z signal Z lies between the two revolutions U1, U2.

Since the maxima are to be determined numerically, the envelope of the structure borne noise signal S is smoothed using the Savitzky-Golay filter (FIGS. 2 and 3).

The signal that is then formed can be seen in FIG. 10. Each maximum (and minimum) can now be associated with one angular position on the circumference of the plain bearing 1 by using the zero pulse signal. This has already been indicated in FIG. 8.

From the above descriptions, it is clear that a plain bearing 1 can be efficiently monitored for rubbing contacts (i.e. mixed friction events a, b, c, d) by arranging a structure borne noise sensor 3 in the vicinity of the plain bearing 1. Together with the pulse generator and a computer for evaluating the data, it is possible in this way to efficiently monitor a plain bearing 1 in a motor or an aircraft engine, for example.

The monitoring of plain bearings 1 in an epicyclic planetary gearbox 20 is described below as one possible application.

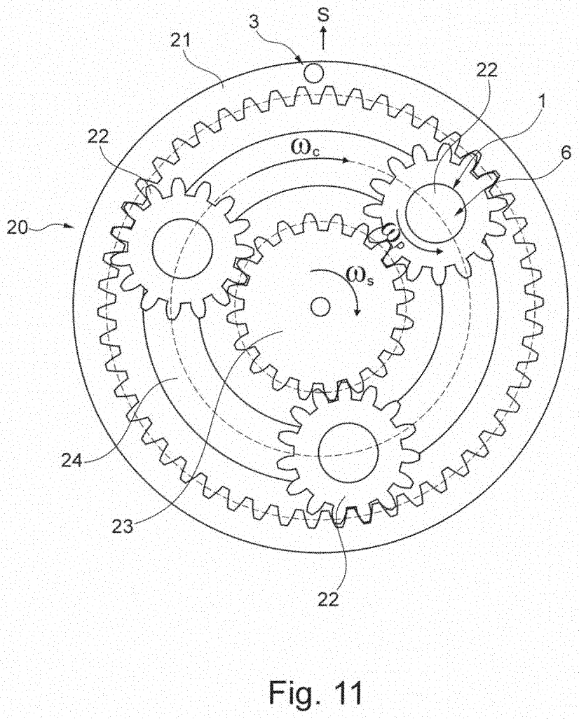

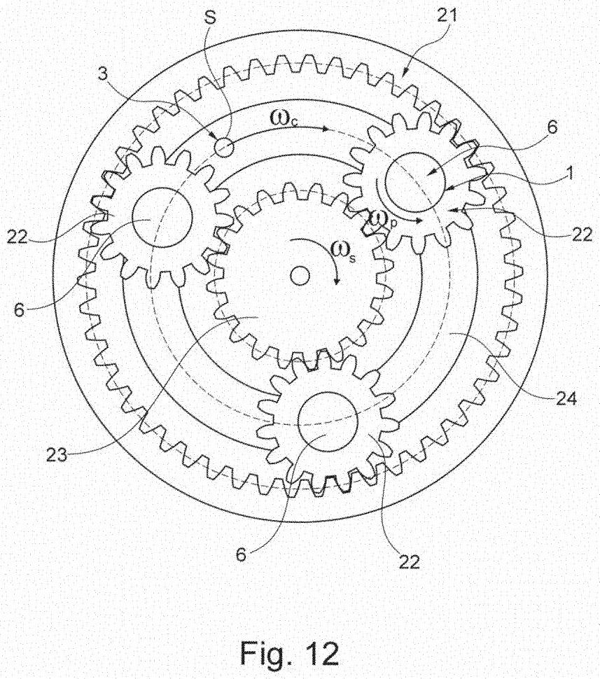

FIG. 11 shows diagrammatically in a front view an epicyclic planetary gearbox 20 having a ring gear 21, three planet gears 22, a sun gear 23 and a carrier 24 (also referred to as a planet carrier). A planetary gearbox 20 of this kind can be installed as a reduction gearbox in a turbofan engine, for example.

The planetary gearbox 20 can be driven via the sun gear 23, which rotates at an angular speed ω_{S}. The planet gears 22 roll on the sun gear 23 and in the ring gear 21, which is assumed to be fixed here. The shafts 6 of the planet gears 22 are supported on the carrier 24 by means of plain bearings 1, with the result that the planet gears 22 rotate at an angular speed ω_{P}. The carrier 24, which forms the output of the planetary gearbox 20 in the illustrated embodiment, rotates around the axis of the sun gear 23 at the angular speed ω_{C}.

In the embodiment shown in FIG. 11, a structure borne noise sensor 3 is installed approximately centrally on the upper edge of the ring gear 21. The structure borne noise of the plain bearings 1 is received by said sensor. The data of the structure borne noise signal S can be transmitted from the structure borne noise sensor 3 to a computer 30 (not shown here) via a cable or wirelessly.

As an alternative, it is also possible for the structure borne noise sensor 3 to be arranged on the corotating carrier 24, as illustrated in FIG. 12. In this case, however, wireless data transmission of the structure borne noise data out of the casing of the planetary gearbox 20 is worthwhile. In other respects, the function of monitoring the plain bearing 1 is as in the embodiment shown in FIG. 10.

Here, the illustration of the epicyclic planetary gearbox 20 should be taken to be only illustrative. In other embodiments, it is possible to use five or more planet gears, for example. It is also possible to choose a different mechanism, that is to say that the input and output differ from the example in FIGS. 10 and 11. In particular, it is possible for different designs to be used for the epicyclic planetary gearbox 20 described here. The monitoring of the plain bearings 1 is performed in a similar way.

### LIST OF REFERENCE SIGNS

1 Plain bearing
2 Holder of plain bearing
3 Structure borne noise sensor
4 Supporting hole for introducing force
5 Oil supply line
6 Shaft
7 First support bearing
8 Second support bearing
9 Electric motor
10 Plain bearing device
20 Planetary gearbox
21 Ring gear
22 Planet gears
23 Sun gear
24 Carrier
30 Computer
a, b, c, d Rubbing contact points, friction events
Aₐ, A_{b}, A_{c}, A_{d} Amplitude of a friction event
B Current operating data
D Output signal
E Count
F_{N} Force introduced
Iₐ, I_{b}, I_{c} Integral measure over one friction event
M Measure of friction event
R Friction event model
S Structure borne noise signal
Tₐ, T_{b}, T_{c}, T_{d} Time duration of a friction event
W Wear model
Z Signal of pulse generator

1. A method for estimating the state of wear of a plain bearing having a shaft mounted therein, in particular rotating therein, wherein at least one time-dependent structure borne noise signal of the plain bearing is recorded by at least one structure borne noise sensor, in particular precisely one structure borne noise sensor, comprising
a) establishing the time profile of at least one friction event from the structure borne noise signal by means of a mathematical friction event model,
b) determination of a measure, which characterizes at least one friction event based on the time duration of the at least one friction event, the amplitude of the at least one friction event and/or an integral measure over the at least one friction event,
c) combination of the measure, accumulated over time, with an angle indication for the at least one friction event at the circumference of the plain bearing in order to determine a spatially resolved wear model of the plain bearing, wherein the spatially resolved wear model (W) is obtained by means of an estimating filter, and
d) outputting of a signal in accordance with the wear model to characterize the state of wear.

2. The method according to claim 1, wherein the spatially resolved wear model is obtained by means of a Kalman filter, an extended Kalman filter and/or a regression.

3. The method according to claim 1, wherein the number of friction events is counted and used to generate a signal for service life estimation.

4. The method according to claim 1, wherein the friction events comprise mixed friction and/or solid body friction events.

5. The method according to claim 1, wherein a correlation of the frequencies of the friction events and/or between the feature determined (from the structure borne noise) and the degree of wear is carried out.

6. The method according to claim 1, wherein current operating data, in particular the operating duration, a temperature, in particular an oil temperature, load data, acoustic data in frequency ranges outside the friction events and/or a measured rotational speed are included in the service life estimation, and/or operating data of structurally identical and/or structurally similar plain bearings are included in the service life estimation and/or priori information is included in the service life estimation.

7. (canceled)

8. (canceled)

9. The method according to claim 1, wherein the friction event model is an envelope curve model which is obtained by means of the following steps:
a) filtering the structure borne noise signal,
b) subsequent calculation of an envelope curve for the filtered structure borne noise signal,
c) subsequent smoothing of the envelope curve.

10. The method according to claim 9, wherein the angle indication for the at least one friction event is obtained from the envelope curve model, in which
a) combination of the data for the smoothed envelope curve with a rotation angle signal dependent on the rotation of the shaft in the plain bearing is carried out,
b) calculation of at least one maximum is carried out, which correlates with the at least one friction event, from the combined data from step a) for the determination of an angle indication for the at least one friction event at the circumference of the plain bearing.

11. The method according to claim 10, wherein the rotation angle signal is determined and/or generated by pattern recognition or by means of a reference pulse by an incremental encoder, in particular a magnetic reference pulse.

12. The method according to claim 10, wherein the rotation angle signal is generated exclusively by the movement of the shaft and/or of the plain bearing, in particular by at least one magnetic element of the shaft and/or in the plain bearing and a correspondingly associated magnetic sensor.

13. The method according to claim 10, wherein the rotation angle signal is generated actively by means of at least one pulse, in particular a zero pulse or a multiplicity of pulses of the incremental encoder.

14. The method according to claim 9, wherein the filtering system has a high pass filter, in particular with a cutoff frequency between 50 and 300 kHz, in particular between 80 and 150 kHz.

15. The method according to claim 9, wherein the calculation of the envelope curve is performed by means of a Hilbert transformation or by averaging over a predetermined quantity of filtered structure borne noise data points.

16. The method according to claim 9, wherein the envelope curve is smoothed by means of a smoothing filter, in particular a Savitzky-Golay filter.

17. The method according to claim 1, wherein the plain bearing is arranged in a planetary gearbox, in particular a planetary gearbox of a wind turbine, a vehicle or an aircraft engine.

18. The method according to claim 1, wherein kinematic motion data and/or structure borne noise events of the planetary gearbox, in particular the motion data and/or structure borne noise events of the movements of the sun gear, planet carrier and/or planet gears, are filtered out.

19. A device for estimating the state of wear of a plain bearing having a shaft mounted therein, in particular rotating therein, with respect to at least one friction event, wherein at least one time-dependent structure borne noise signal can be recorded by at least one structure borne noise sensor, in particular precisely one structure borne noise sensor of the plain bearing, having
a first computation means for establishing the time profile of at least one friction event from the structure borne noise signal by means of a mathematical friction event model,
a second computation means for determining a measure, which characterizes the at least one friction event based on the time duration of the at least one friction event, the amplitude of the at least one friction event and/or an integral measure over the at least one friction event,
a third computation means for combining the measure, accumulated over time, with an angle indication for the at least one friction event at the circumference of the plain bearing in order to determine a spatially resolved wear model of the wear model of the plain bearing (1), wherein the spatially resolved wear model is obtained by means of an estimating filter, and
a signaling means for outputting a signal in accordance with the model to characterize the state of wear.

20. The device according to claim 19, wherein the at least one structure borne noise sensor is arranged on the end of a holder of the plain bearing.

21. The device according to claim 19, wherein the at least one structure borne noise sensor has a piezoelectric element for recording the structure borne noise.

22. The device according to claim 19, wherein the at least one structure borne noise sensor is arranged in the immediate vicinity of the circumference of the plain bearing, in particular in the immediate vicinity of the introduction of a force.
